(19) United States
(12) Patent Application Publication
(10) Pub. No.: US 2006/0243075 A1
(43) Pub. Date: Nov. 2, 2006

(54) Linear actuator with quick release mechanism

(75) Inventors: Pzung-Cheng Liou, Taichung (TW); Chia-Yu Lin, Taichung (TW)

Correspondence Address: CHARLES E. BAXLEY, ESQ., 90 JOHN STREET, THIRD FLOOR, NEW YORK, NY, 10038, US

(73) Assignee: Hiwin Mikrosystem Corp.

(21) Appl. No.: 11/119,950

(22) Filed: May 2, 2005

(51) Int. Cl. F16H 27/02

(52) U.S. Cl. 74/89.39

(57) ABSTRACT

A linear actuator with quick release mechanism comprises: a power unit for outputting torque; a transmission device including a screw shaft, a screw nut and an inner tube, the screw shaft connected to the power unit for the purpose of power transmission, the screw nut screwed on the screw shaft for converting torque into linear motion, the inner tube being fixed on the screw nut and rotated together with the screw nut; a load connector for connecting a load and making the load move linearly; and a quick release mechanism is disposed between the transmission device and the load connector, and is coaxially connected to the inner tube and the load connector.

### BACKGROUND OF THE INVENTION

1. Field of the Invention

The present invention relates to a linear actuator with quick release mechanism, the linear actuator is used on reciprocating equipments, and the quick release mechanism is able to withdraw the load without the need of any power supply.

2. Description of the Prior Arts

A linear actuator generally comprises a motor, an output shaft, a transmission shaft, a screw shaft, a screw nut and an inner tube. Initially the motor outputs torque to the output shaft that is axially engaged with the transmission shaft, so that the torque is then transmitted from the output shaft to the transmission shaft. On the transmission shaft is provided the screw shaft that is screwed with the screw nut, and the screw nut is connected to the inner tube. When the screw shaft rotates with the transmission shaft, the screw nut will convert the torque of the screw shaft into linear push or pull force, and as a result, the inner tube will be caused to move back and forth reciprocatingly to move the load.

However, in an emergency or in the absence of power, the linear actuator must be used if want to withdraw the inner tube of the linear actuator and the load thereon quickly.

EP 0685662 discloses a quick release mechanism for linear actuator is designed in the form of a shaft coupling that is disposed between the transmission shaft and the screw shaft, so that the motor, the output shaft and transmission shaft can be released from the screw shaft, the screw nut and the inner tube simply by releasing the shaft coupling. Therefore, the screw shaft can rotate freely within the screw nut, this, in turn, can cause withdrawal of the inner tube. Due to the quick release design of the linear actuator, the load and the inner tube is almost withdrawn instantly at a very high speed, inevitably, a very great impact force will be generated to the load and the linear actuator, and this may cause damage to them.

Another conventional quick release mechanism for linear actuator as disclosed in U.S. Pat. No. 6,158,295 is able to control the inner tube and load withdrawal speed and can get rid of the impact force problem. However, this type quick release mechanism must comprise a planet gear set, during release operation, the inner gear and the planet gear, besides self-rotation, will also revolve around the central gear. Furthermore, the axial force needs to be converted into radial force in order to loosen the sliding block. Therefore, this quick release mechanism is too complicated, and its application is limited.

The present invention has arisen to mitigate and/or obviate the afore-described disadvantages.

### SUMMARY OF THE INVENTION

The primary objective of the present invention is to provide a linear actuator with quick release mechanism that is able to withdraw the load without the need of any power supply and is able to control the movement distance and speed of the load, this is achieved by interrupting the power transmission between the power source and the load, and finally the weight of the load is used to withdraw the load quickly.

The linear actuator with quick release mechanism comprises: a power unit for outputting torque; a transmission device including a screw shaft, a screw nut and an inner tube, the screw shaft connected to the power unit for the purpose of power transmission, the screw nut screwed on the screw shaft for converting torque into linear motion, the inner tube being fixed on the screw nut and rotated together with the screw nut; a load connector for connecting a load and making the load move linearly; and a quick release mechanism being disposed between the transmission device and the load connector, and coaxially connected to the inner tube and the load connector.

The quick release mechanism includes a rotary portion, a non-rotary portion and a spring, wherein the rotary portion is connected to the inner tube, the non-rotary portion is connected to the load connector, and the rotary portion and the non-rotary portion are connected by the spring, so that the power is allowed to be transmitted from the inner tube to the load connector so as to make the load move linearly, and the rotary portion also can disengage the non-rotary portion so as to withdraw the load.

The spring is formed at an end thereof with an inward hook that is fixed on the load connector, another end of the spring is formed with an outward hook, so that a clamping force of the spring applied on the rotary portion will be adjusted simply by pulling the outward hook, when the clamping force applied on the rotary portion is larger than a connecting force between the rotary portion and the non-rotary portion, the rotary portion will be locked with the non-rotary portion, at this moment, power will be transmitted and the load will be caused to move, when the clamping force applied on the rotary portion is less than the connecting force between the rotary portion and the non-rotary portion, the rotary portion will be disengaged from the non-rotary portion, and this will cause withdrawal of the load.

The clamping force of the spring will be adjusted by pulling the outward hook, and thus velocity of the load will also be adjusted through adjustment of the clamping force of the spring.

The clamping force of the spring will be adjusted by pulling the outward hook, and thus movement distance of the load will be adjusted through adjustment of the clamping force of the spring.

The quick release mechanism includes a handle that is formed with a notch for accommodation of the out hook of the spring.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is an exploded view of a linear actuator with quick release mechanism in accordance with an embodiment of the present invention;

FIG. 2 is a cross sectional view of FIG. 1;

FIG. 3 is an amplified view of a part of FIG. 2.

### DETAILED DESCRIPTION OF THE PREFERRED EMBODIMENT

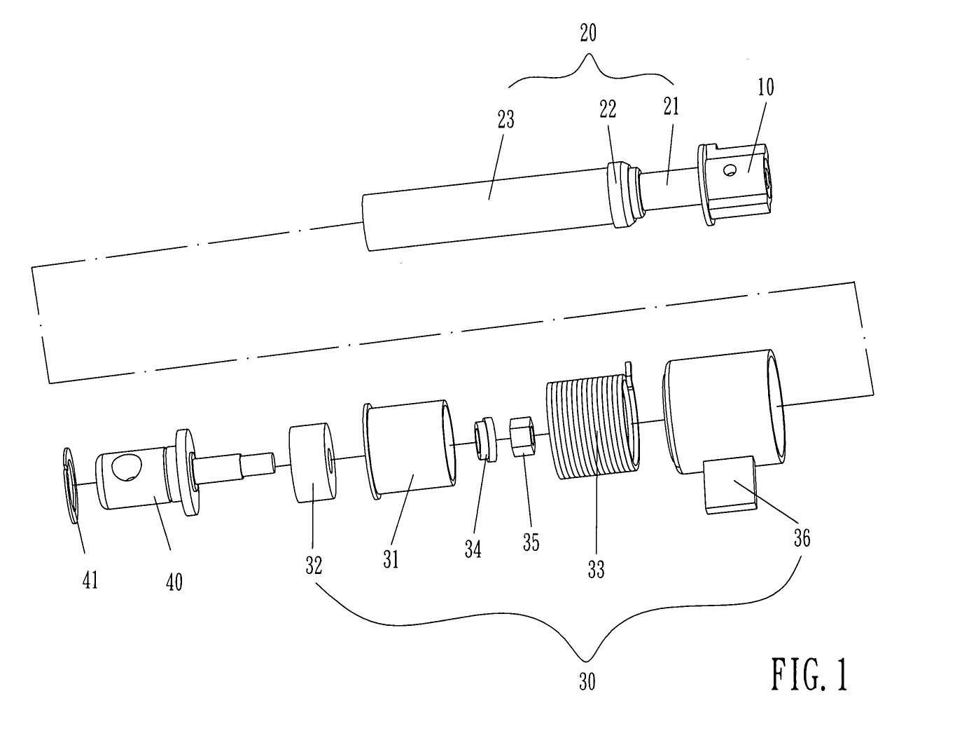

FIG. 1 is an exploded view of a linear actuator with quick release mechanism in accordance with an embodiment of the present invention, in which, a power unit 10 is a power resource for outputting torque to a transmission device 20 which includes a screw shaft 21, a screw net 22 and an inner tube 23. A quick release mechanism 30 is disposed between the transmission shaft 20 and a load connector 40. The screw shaft 21 is connected to the power unit 10 for the purpose of power transmission. The screw nut 22 is screwed on the screw shaft 21 for converting torque into linear motion. The inner tube 23 is fixed on the screw nut 22 and rotates together with the screw nut 22, a rear end of the inner tube 23 is fixed to an inner periphery of the front end of a sleeve 31, on the outer periphery of the sleeve 31 is mounted a spring 33, and then mounted on the spring 33 is a handle 36. An inner periphery of the rear end of the sleeve 31 mates with the outer periphery of a ball bearing 32 whose inner periphery mates with the front end of the load connector 40 and is fixed therein by a washer 34 and a fixing nut 35 that are fixed on the outer periphery of the front end of the load connector 40. And finally the handle 36 is locked on the load connector 40 by means of a retainer ring 41.

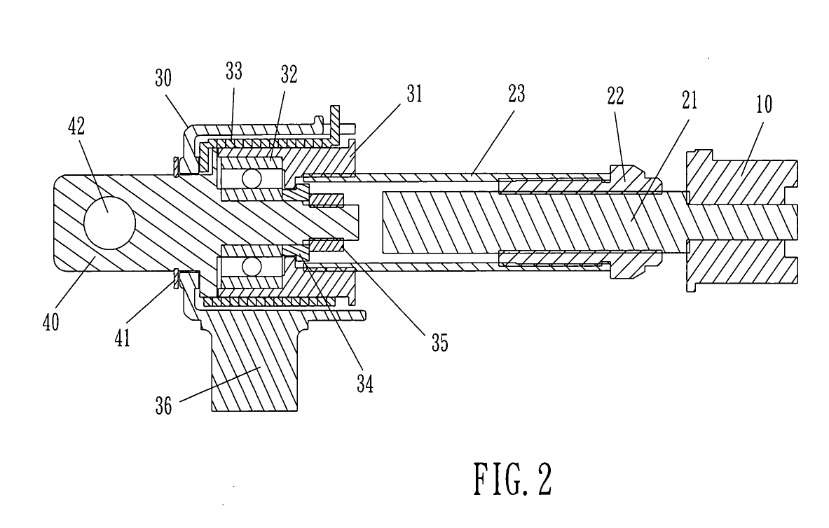

FIG. 2 is a cross sectional view of FIG. 1, in which, the power unit 10 rotates the screw shaft 21, and the screw nut 22 serves to convert rotation into linear motion, so as to make the inner tube 23 on the screw nut 22 reciprocate linearly. The quick release mechanism 30 is coaxially connected to the inner tube 23 and the load connector 40, and includes a rotary portion, a non-rotary portion and the spring 33. The rotary portion includes the sleeve 31 and the outer periphery of the ball bearing 32, while the non-rotary portion comprises the inner periphery of the ball bearing 32, the washer 34 and the fixing nut 35. The sleeve 31 of the rotary portion is connected to the inner tube 23, while the inner periphery of the ball bearing 32, the washer 34 and the fixing nut 35 of the non-rotary portion are axially connected to the load connector 40. The rotary portion and the non-rotary portion are connected by the spring 33, so as to transmit power from the inner tube 23 to the load connector 40, on the load connector 40 is provided a connecting hole 42 for connection of load (not shown), so as to move the load and to release the rotary portion from the non-rotary portion, thus causing withdrawal of the load.

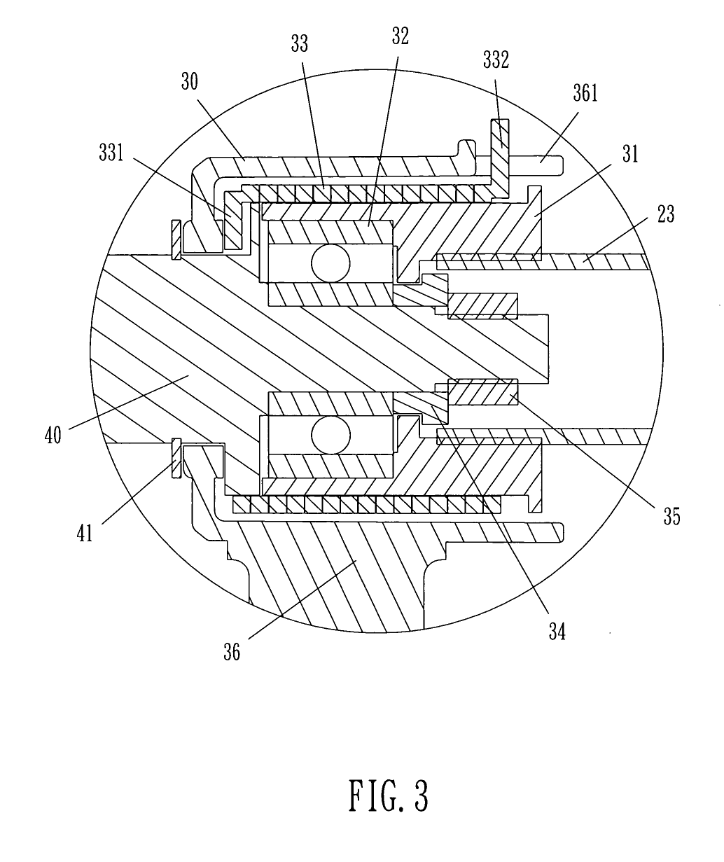

FIG. 3 is an amplified view of a part of FIG. 2, the spring 33 of the quick release mechanism is formed at an end thereof with an inward hook 331 that is fixed on the load connector 40, another end of the spring 33 is formed with an outward hook 332 employed to be locked in a notch 361 of the handle 36, so that the clamping force of the spring 33 applied on the sleeve 31 can be adjusted simply by pulling the outward hook 332. Since the inward end 331 of the spring 33 is fixed on the load connector 40, when the outward hook 332 of the spring 33 is not being pulled, the spring 33 will be compressed inward to clamp the sleeve 31 very tightly, so that the sleeve 31 and the outer periphery of the ball bearing 32 will be locked together with the non-rotary portion and become unrotatable, at this moment, the power can be transmitted and, consequently, the load can be driven to move. However, when pulling the outward hook 332 to make the spring 33 expand outward, the clamping force applied on the sleeve 31 will be less than the connecting force between the rotary portion and the non-rotary portion, the sleeve 31 and the outer periphery of the ball bearing 32 of the rotary portion will disengage the non-rotary portion and become rotatable. At this moment, the weight of the load will generate a force to make the screw nut 22 (as shown in FIG. 2), the inner tube 23, the sleeve 31 and the outer periphery of the ball bearing 32 rotate, thus the load can be withdrawn quickly.

The present invention has the following advantages:

First, the quick release mechanism of linear actuator in accordance with the present invention can be made in the form of a mould and is disposed between the inner tube and the load connector of the linear actuator, the quick release mechanism has a wider application and is simply structured for easy assembly.

Second, the quick release mechanism of linear actuator in accordance with the present invention employs the spring to adjust the clamping force, so that the load withdrawal speed and distance are controllable, and the impact force can be reduced. Thus improving the safety and the service life of the linear actuator.

While we have shown and described various embodiments in accordance with the present invention, it should be clear to those skilled in the art that further embodiments may be made without departing from the scope of the present invention.

What is claimed is:

1. A linear actuator with quick release mechanism comprising:
a power unit for outputting torque;
a transmission device including a screw shaft, a screw nut and an inner tube, the screw shaft connected to the power unit for the purpose of power transmission, the screw nut screwed on the screw shaft for converting torque into linear motion, the inner tube being fixed on the screw nut and rotated together with the screw nut;
a load connector for connecting a load and making the load move linearly;
a quick release mechanism being disposed between the transmission device and the load connector, and coaxially connected to the inner tube and the load connector, the quick release mechanism including a rotary portion, a non-rotary portion and a spring, wherein the rotary portion is connected to the inner tube, the non-rotary portion is connected to the load connector, and the rotary portion and the non-rotary portion are connected by the spring, so that the power is allowed to be transmitted from the inner tube to the load connector so as to make the load move linearly, and the rotary portion also can disengage the non-rotary portion so as to withdraw the load.

2. The linear actuator with quick release mechanism as claimed in claim 1, wherein the spring is formed at an end thereof with an inward hook that is fixed on the load connector, another end of the spring is formed with an outward hook, so that a clamping force of the spring applied on the rotary portion will be adjusted simply by pulling the outward hook, when the clamping force applied on the rotary portion is larger than a connecting force between the rotary portion and the non-rotary portion, the rotary portion will be locked with the non-rotary portion, at this moment, power will be transmitted and the load will be caused to move, when the clamping force applied on the rotary portion is less than the connecting force between the rotary portion and the non-rotary portion, the rotary portion will be disengaged from the non-rotary portion, and this will cause withdrawal of the load.

3. The linear actuator with quick release mechanism as claimed in claim 1, wherein the clamping force of the spring will be adjusted by pulling the outward hook, and thus velocity of the load will also be adjusted through adjustment of the clamping force of the spring.

4. The linear actuator with quick release mechanism as claimed in claim 2, wherein the clamping force of the spring will be adjusted by pulling the outward hook, and thus velocity of the load will be adjusted through adjustment of the clamping force of the spring.

5. The linear actuator with quick release mechanism as claimed in claim 1, wherein the clamping force of the spring will be adjusted by pulling the outward hook, and thus movement distance of the load will be adjusted through adjustment of the clamping force of the spring.

6. The linear actuator with quick release mechanism as claimed in claim 2, wherein the clamping force of the spring will be adjusted by pulling the outward hook, and thus movement distance of the load will be adjusted through adjustment of the clamping force of the spring.

7. The linear actuator with quick release mechanism as claimed in claim 1, wherein the rotary portion of includes a sleeve, and an outer periphery of the ball bearing, and the non-rotary portion comprises an inner periphery of the ball bearing, a washer and a fixing nut.

8. The linear actuator with quick release mechanism as claimed in claim 2, wherein the rotary portion of includes a sleeve, and an outer periphery of the ball bearing, and the non-rotary portion comprises an inner periphery of the ball bearing, a washer and a fixing nut.

9. The linear actuator with quick release mechanism as claimed in claim 2 further includes a handle that is formed with a notch for accommodation of the out hook of the spring.
